(19) United States
(12) Patent Application Publication
(10) Pub. No.: US 2003/0004994 A1
(43) Pub. Date: Jan. 2, 2003

(54) Method and apparatus for content based HTML coding

(76) Inventors: Brian J. Kamrowski, (US); Steven P. Poulsen, (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/892,733

(22) Filed: Jun. 28, 2001

(51) Int. Cl. G06F 17/21

(52) U.S. Cl. 707/513

(57) ABSTRACT

Method and apparatus for content based HyperText Markup Language (HTML) coding. A computing device such as a server may include an HTML simplifier, encoder, and memory. Source HTML data may be accessed that presents HTML web pages. The HTML data is simplified. The simplification minimizes the size of the HTML data. Prior knowledge of the HTML data may be used during the simplification. The simplified HTML data is encoded using a Huffman code. The encoded/compressed HTML data is stored. HTML data is encoded/compressed based on an empirical study of common HTML pages, therefore, providing optimization and performance gains.

### BACKGROUND

1. Field of the Invention

This invention relates to HyperText Markup Language (HTML), and more specifically to content based compression of HTML.

2. Background Information

With the Internet increasing in popularity and use, more and more individuals, corporations and organizations are developing and making available web pages for access by users at client machines. These web pages generally reside at servers that receive requests from client machines for access these web pages. Browsers at client machines receive the web pages from the server for display at the client machine. The web pages may have been created using HyperText Mark-up Language (HTML) or Extensible Mark-up Language (XML), and may be transmitted from the server to the client machine using Hypertext Transfer Protocol (HTTP).

Most HTTP data transmitted from a web server to a client browser is standard HTML ASCII (American Standard Code for Information Interchange) text. One or more bytes of the HTTP data represent each character of the HTML source. With this current approach, no HTML specific optimization is performed. Therefore, Internet bandwidth is wasted since HTML data is highly compressible. Web server resources are also wasted because a unique web server port is opened for each client. The port remains open during the entire HTTP session.

Compressed (i.e., coded) HTML is discussed in RFC 2068 §3.5. This document includes various forms of widely used compression algorithms. However, the compression algorithms referenced in RFC 2068 are very generic and not tailored for HTML. They do not leverage several potential size and performance gains achievable with HTML.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 shows a block diagram of a server according to an example embodiment of the present invention;

FIG. 2 shows a flowchart of an example process for content based HTML coding according to an example embodiment of the present invention; and

FIG. 3 shows a flowchart of an example simplification process according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention relates to method and apparatus for content based HTML coding where prior knowledge of source HTTP data may be leveraged and used to compress the HTTP data for more efficient storage and transmission to a client machine. HTML data is simplified and then encoded using a Huffman code to provide increased performance gains and optimization of the HTML data. The encoded data may then be stored in memory, e.g., a cache, at a web server until the web pages or content represented by the HTML data is requested by a client machine.

The simplification of HTML data may include any or all of several processes. Each character of a U.S. English web page may be represented with a small amount data. The only necessary ASCII characters may be A-Z, a-z, 0-9, and several punctuation characters. Infrequent characters may be represented with known Universal Resource Locator (URL) escaped notation. For example, the character “ˆ ” is rarely used and, therefore, may be represented by its ASCII hexadecimal value %5e. Case may be ignored for several elements of an HTML page. Moreover, white space (blank spaces) and comments may be removed. HTML pages are written with a mark-up language. Therefore, the grammar of the language may be used in the compression. For example, the most common element found in an HTML page is <A href=″>. This entire element may be replaced by a single value and the element rebuilt when the page is uncompressed. Elements inside of HTML tags may be reordered to match the coding symbols. This does not alter the functionality or appearance of the rendered HTML page. An entire byte value is not required for each HTML character and, therefore, multiple characters may be encoded into a single byte. For example, the term <A href=″> that consists of multiple characters, may be simplified (e.g., encoded) into a single byte.

The simplified HTML data may then be encoded. Although, many encoders may be used and still be within the spirit and scope of the present invention, use of a Huffman code is advantageous for the coding of HTML data. A Huffman code may be generated empirically by analyzing thousands of industry standard HTML pages. A brute force iterative method may be employed to produce the ideal code. A Huffman code produces a tree structure with the encoding of the data. The most frequently occurring data and data patterns occur at the top of the tree. The least occurring data is at the bottom of the tree. HTML is encoded by parsing the tree. A common HTML string may be represented with a few bits rather than several bytes. After Huffman encoding, the HTML data is represented in binary format. The Huffman tree may not be communicated between clients and a server since each network device may contain its own copy. Moreover, multiple Huffman codes may be utilized. In one embodiment of the present invention, only the source HTML data may be compressed, and not images or text data outside of HTML tags. The HTML source data may be converted to some normalized set of data before the HTML data is compressed, therefore, providing a smaller Huffman tree that compresses the same amount of information. Therefore, optimization may be within the HTML tags. Further, attributes within the HTML data may be reordered to get better pattern matches.

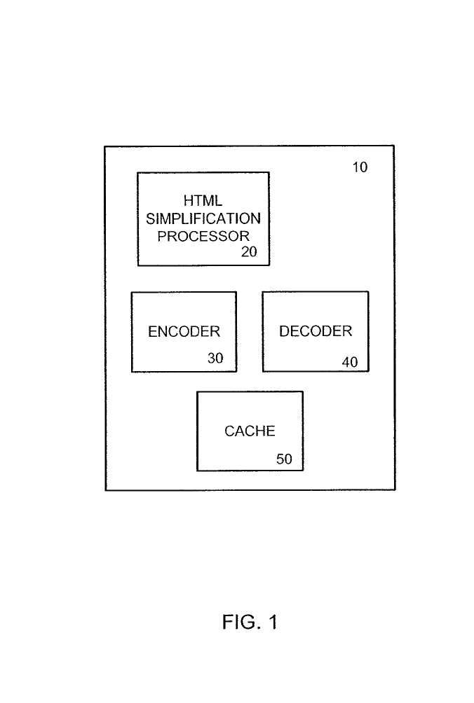

FIG. 1 shows a block diagram of a server according to an example embodiment of the present invention. Server 10 may include an HTML simplification processor 20, an encoder 30, a decoder 40, and a storage device such as a cache 50. Server 10 may be a host for web pages and a particular web site. The HTML that represents the web pages, after having been created by a developer, may be simplified in simplification processor 20. This result may then be compressed by generating a Huffman code of the simplified HTML data by encoder 30. The result of the Huffman coding represents an encoded version of the HTML data. The compressed/encoded HTML data represents the web pages and may then be stored in cache 50. The function of HTML simplification processor 20, encoder 30, and decoder 40 may be performed by hardware, in software, or by a combination thereof. Server 10 may also include a network interface for interfacing to client or other computing devices desiring access to the HTML data or content.

A client machine desiring access to the web site hosted by server 10 may make a request to server 10 for access to the web site. As part of the request, a coding field may exist that allows the browser at the client machine to notify a server of which compression, encryption, etc. algorithms the browser can handle (e.g., compressed HTML). The coding field information may be used by the client machine and server 10 to negotiate for different ways of communicating. If the browser can handle the compressed HTML, as encoded and stored in cache 50, server 10 may reply to the client's request by transmitting the encoded data from cache 50 to the client machine.

The client machine may decode the HTML data (i.e., web pages) by applying the encoded data to the Huffman tree in reverse. The unencoded data may then be used by the browser at the client machine. If the client machine cannot handle compressed data, decoder 40 may be used at server 10 to unencode the HTML data in cache 50. The unencoded versions of the web pages may then be sent to the client machine. Further, for client machines that do not have the Huffman tree needed for decoding, server 10 may automatically install the Huffman tree at the client machine, therefore allowing the client machine to unencode the compressed HTML pages.

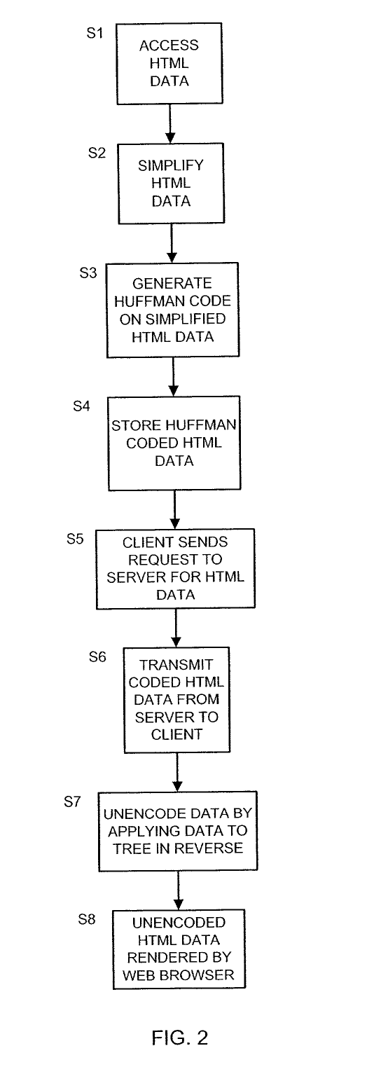

FIG. 2 shows a flowchart of an example process for content based HTML coding according to an example embodiment of the present invention. A server or other processing device first accesses the HTML data S1. The HTML data may represent HTML web pages. The HTML pages may then be simplified S2. A Huffman code may then be generated for the simplified pages S3. The result of the Huffman coding may then be stored S4. A client may then send a request to the server for the HTML pages S5. The server may then transmit the coded (i.e., compressed) HTML pages to the client device S6. The client may then unencode the pages by applying the coded data to the Huffman tree in reverse S7. The unencoded HTML pages may then be rendered by a web browser at the client machine S8.

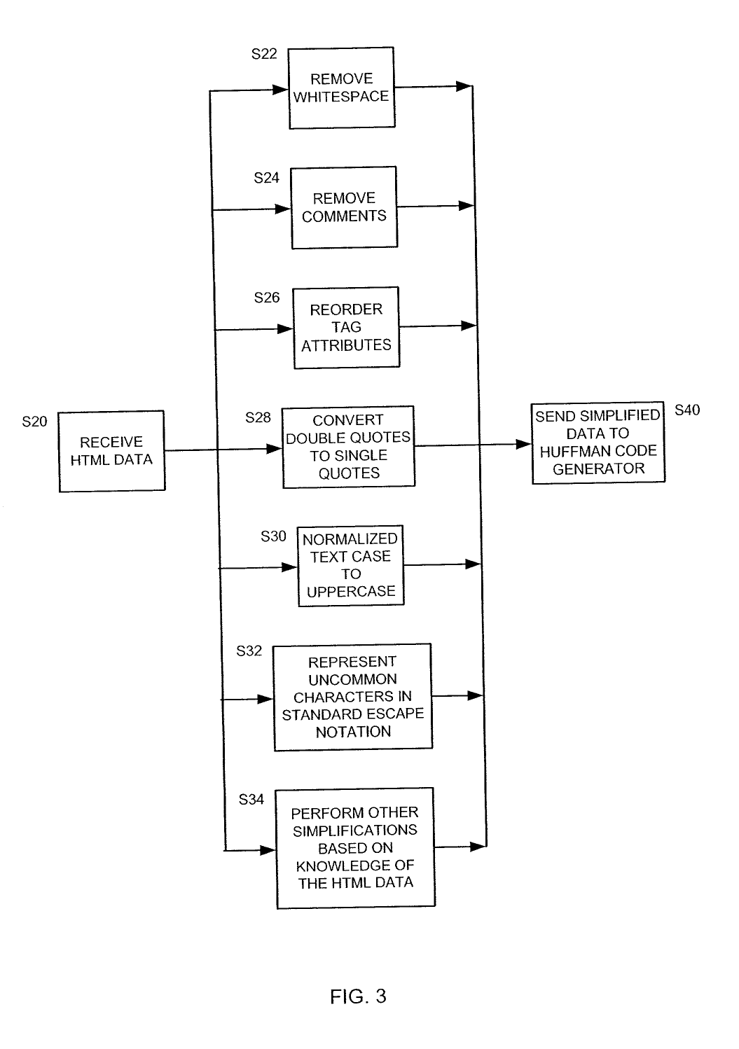

FIG. 3 shows a flowchart of an example simplification process according to an example embodiment of the present invention. One or more HTML pages are received S20. A number of different processes or tasks may then operate on the HTML pages sequentially or in parallel. All spaces (white space) may be removed from the HTML pages S22. All comments may be removed from the HTML pages S24. Tag attributes within the HTML pages may be reordered S26. All double quotes in the HTML pages may be converted to single quotes (or vice versa) S28. All text in the HTML pages may be normalized. For example, the text case may be normalized to upper case S30. Uncommon characters found in the HTML pages may be represented in standard escape notation S32. Further, other simplifications may be performed based on knowledge of the HTML data S34. For example, multiple characters may be encoded into a single byte. At the conclusion of the simplification process, the simplified pages may be sent to an encoder, such as a Huffman code generator S40.

The present invention is advantageous in that methods and apparatus according to the present invention provide compression tailored for HTML. Apparatus and methods according to the present invention provide a compression scheme that leverages the inherent compressability of HTML. According to the present invention, HTML may be compressed based on an empirical study of common HTML pages, therefore, providing optimization and performance gains not achieved by other compression schemes.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A method for content based HyperText Markup Language (HTML) coding comprising:
accessing source HTML data;
simplifying the HTML data, the simplifying minimizing the size of the HTML data, knowledge of the HTML data being used during the simplification;
encoding the simplified HTML data; and
storing the encoded HTML data.

2. The method according to claim 1, further comprising transmitting the encoded HTML data to a computing device in response to a request from the computing device for access to the HTML data.

3. The method according to claim 2, further comprising transmitting the encoded data from a server to the computing device.

4. The method according to claim 1, wherein the HTML data represents at least one web page.

5. The method according to claim 1, wherein the simplification includes removal of spaces from the HTML data.

6. The method according to claim 1, wherein the simplification includes removal of comments from the HTML data.

7. The method according to claim 1, wherein the simplification includes normalizing the case of text in the HTML data.

8. The method according to claim 1, wherein the simplification includes reordering tag attributes in the HTML data.

9. The method according to claim 1, wherein the simplification includes representing some characters in the HTML data in standard escape notation.

10. The method according to claim 1, wherein the simplification includes encoding multiple characters in the HTML data into a single byte.

11. The method according to claim 1, wherein the encoding comprises generating a Huffman code for the simplified HTML data.

12. The method according to claim 1, further comprising storing the encoded HTML data in a cache.

13. An apparatus comprising a storage medium with instructions stored therein, the instructions when executed causing a computing device to perform:
accessing source HTML data;
simplifying the HTML data, the simplifying minimizing the size of the HTML data, knowledge of the HTML data being used during the simplification;
encoding the simplified HTML data; and
storing the encoded HTML data.

14. The apparatus according to claim 13, wherein the HTML data represents at least one web page.

15. The apparatus according to claim 13, the instructions when executed causing a computing device to further perform transmitting the encoded HTML data to a computing device in response to a request from the computing device for access to the HTML data.

16. The apparatus according to claim 15, the instructions when executed causing a computing device to further perform transmitting the encoded data from a server to the computing device.

17. A server device comprising:
a HTML simplifier, the HTML simplifier capable of simplifying source HTML data, the simplifying minimizing the size of the HTML data, knowledge of the HTML data being used during the simplification;
an encoder; the encoder capable of encoding the simplified HTML data; and
a memory device, the encoded HTML data being stored in the memory device.

18. The server according to claim 17, wherein the simplification includes removal of spaces from the HTML data.

19. The server according to claim 17, wherein the simplification includes removal of comments from the HTML data.

20. The server according to claim 17, wherein the simplification includes normalizing the case of text in the HTML data.

21. The server according to claim 17, wherein the simplification includes reordering tag attributes in the HTML data.

22. The server according to claim 17, wherein the simplification includes representing some characters in the HTML data in standard escape notation.

23. The server according to claim 17, wherein the simplification includes encoding multiple characters in the HTML data into a single byte.

24. The server according to claim 17, wherein the encoding comprises generating a Huffman code for the simplified HTML data.

25. The server according to claim 17, further comprising storing the encoded HTML data in a cache.

26. The server according to claim 17, wherein the HTML data represents at least one web page.

27. The server according to claim 17, further comprising a network interface, the server transmitting the encoded HTML data over the network interface to a computing device in response to a request from the computing device for access to the HTML data.

28. The server according to claim 27, further perform transmitting the encoded data from a server to the computing device.
